(19) United States
(12) Patent Application Publication
(10) Pub. No.: US 2024/0173688 A1
(43) Pub. Date: May 30, 2024

(54) SOLAR-BASED REACTOR TUBES AND RELATED SYSTEMS AND METHODS

(71) Applicant: Saudi Arabian Oil Company, Dhahran (SA)

(72) Inventors: Osamah Siddiqui, Dhahran (SA); Sai P. Katikaneni, Dhahran (SA); Bandar Solami, Dhahran (SA); Stephen N. Paglieri, Dhahran (SA); Mohammad Abdur Rakib, Dhahran (SA); Kunho Lee, Dhahran (SA)

(21) Appl. No.: 18/072,177

(22) Filed: Nov. 30, 2022

(51) Int. Cl. B01J 19/24; B01J 15/00; B01J 19/00; B01J 19/28; C01B 3/04

(52) U.S. Cl. CPC B01J 19/2475; B01J 15/005; B01J 19/0013; B01J 19/2415; B01J 19/28; C01B 3/047; B01J 2219/00144

(57) ABSTRACT

The disclosure relates to solar-based reactor tubes and related systems and methods. In general, the reactor tube includes an exterior cylinder, a cylindrical hydrogen-permeable membrane disposed in an interior space of the exterior cylinder, an annular space defined by an outer surface of the cylindrical hydrogen-permeable membrane and an inner surface of the exterior cylinder, a catalyst, and a heating element. A first gas stream and a second gas stream can be configured to pass through the reactor tube. The systems can be used to produce hydrogen (e.g., from ammonia cracking).

### FIELD

The disclosure relates to solar-based reactor tubes and related systems and methods.

### BACKGROUND

Ammonia cracking is an endothermic process to form hydrogen and nitrogen. The conversion of ammonia can be increased by the removal of hydrogen from the reaction environment, which can be achieved using a membrane reactor. In general, such a membrane reactor has two compartments, separated by a membrane selectively permeable to hydrogen.

Solar-based reactor tubes can be used to harness solar energy to drive chemical reactions, such as, for example, the generation of hydrogen from ammonia cracking. The reactor tubes can have heat gradients due to temperature changes induced by different reaction rates in the reactor tube, uneven heating from parabolic trough solar collectors, and varying solar intensities.

### SUMMARY

The disclosure relates to solar-based reactor tubes and related systems and methods. In general, the reactor tube includes an exterior cylinder, a cylindrical hydrogen-permeable membrane disposed in an interior space of the exterior cylinder, an annular space defined by an outer surface of the cylindrical hydrogen-permeable membrane and an inner surface of the exterior cylinder, a catalyst, and a heating element. A first gas stream and a second gas stream can be configured to pass through the reactor tube. The systems can be used to produce hydrogen (e.g., from ammonia cracking).

The systems and methods use both solar thermal collectors and photovoltaic panels to provide energy to the reactor tube via thermal and electrical heating, respectively. Thus, the systems can produce hydrogen from ammonia with reduced emissions and/or operating costs relative to certain other systems, such as systems that use natural gas or other fossil fuels to obtain the desired reaction temperatures in ammonia cracking to produce hydrogen.

The reactor tubes, and related systems and methods of the disclosure have electrical heating elements disposed therein, which can allow improved control of the reactor temperature, relative to reactor tubes that rely solely on solar thermal energy for heating. By increasing or decreasing the heat provided by the electrical heating elements to the reactor tubes as desired, the electrical heating elements can reduce thermal gradients in both the radial and longitudinal directions of the reactor, relative to other reactor tubes that rely solely on solar thermal energy for heating. The reactor tubes, and related systems and methods of the disclosure can therefore reduce (e.g., prevent) temperature gradients resulting from temperature changes due to endothermic and exothermic reactions occurring in the reactor tubes. Endothermic reactions can lead to a temperature drop while exothermic reactions can lead to a temperature rise in the initial region of the reactor tube where the highest rates of reaction exist. Using electrical heating elements connected to different regions of the reactor tube allows for the control of electrical input to these regions such that temperature gradients are reduced (e.g., prevented). For example, regions of the reactor tube undergoing a decrease in temperature due to an endothermic reaction can be provided with increased heating via the electrical heating elements relative to other regions. As another example, the amount of heat supplied by the electrical heating elements in regions of the reactor tube undergoing an increase in temperature due to an exothermic reaction can be reduced to attain a relatively uniform temperature distribution in the reactor. The reactor tubes, and related systems and methods exhibit reduced thermal gradients and reduced loss of performance associated with thermal gradients relative to reactor tubes that rely solely on solar thermal energy for heating, as the electrical heating elements are embedded within the reactor tube. By supplying a portion of the heating used to drive the reactions in the reactor tube with controllable electrical heating elements, the reactor tubes and related systems and methods can reduce (e.g., prevent) catalyst deactivation due to high temperatures while maintaining a desired reaction rate and temperature conditions in the reactor tube.

The systems and methods can also include rotators to rotate the reactor tubes. This can also help even out temperature gradients across the reactor tubes.

The reactor tubes, and related systems and methods of the disclosure include electrical heating elements, thermal energy storage systems and electrical energy based storage systems allowing the use of the reactor tubes during periods of insufficient solar energy availability.

In a first aspect, the disclosure provides a system including a reactor tube. The reactor tube includes a first cylinder having an inner surface defining an interior of the first cylinder, a second cylinder including a hydrogen-permeable membrane disposed within the interior of the first cylinder, a catalyst, a heating element, a first inlet, and a second inlet. The reactor tube has an annular space between an interior surface of the first cylinder and an exterior surface of the second cylinder. The reactor tube has an inner space defined by an interior surface of the second cylinder. The first inlet is configured to allow a first gas stream to pass through a first member selected from the group consisting of the annular space and the inner space. The second inlet is configured to allow a second gas stream to pass through a second member selected from the group consisting of the annular space and the inner space. The second member is different from the first member.

In some embodiments, the catalyst and the heating element are disposed in the annular space, the first inlet is configured to allow the first gas stream to pass through the annular space, the second inlet is configured to allow the second gas stream to pass through the inner space, the first gas stream includes a reactant gas, and the second gas stream includes a sweep gas.

In some embodiments, the catalyst and the heating element are disposed in the inner space, the first inlet is configured to allow the first gas stream to pass through the inner space, the second inlet is configured to allow the second gas stream to pass through the annular space, the first gas stream includes a sweep gas, and the second gas stream includes a reactant gas.

In some embodiments, the system further includes a parabolic trough solar collector configured to transfer solar thermal energy to the reactor tube to heat the reactor tube.

In some embodiments, the system further includes a photovoltaic panel configured to generate electrical energy transferrable to the heating element.

In some embodiments, the system further includes a rotor configured to rotate the reactor tube and the photovoltaic panel is configured to generate electrical energy transferable to the rotor.

In some embodiments, the system further includes an energy storage system configured to store the electrical energy generated by the photovoltaic panel.

In some embodiments, the system further includes a rotor configured to rotate the reactor tube.

In some embodiments, the system further includes a first thermal energy storage system configured to heat the first gas stream before the first gas stream enters the reactor tube, and a second thermal energy storage system configured to heat the second gas stream before the second gas stream enters the reactor tube.

In some embodiments, the system further includes an absorber coating supported by an exterior surface of the first cylinder, wherein the absorber is configured to absorb solar energy to heat the reactor tube.

In some embodiments, the system further includes an enclosure. The heating element is disposed in the enclosure and the enclosure prevents direct physical contact of the heating element and the catalyst.

In a second aspect, the disclosure provides a method that includes: using solar power to heat a reactor tube; passing a reactant-containing gas through a first region of the heated reactor tube so that a catalyst in the first region of the heated reactor tube catalyzes a reaction of the reactant-containing gas to produce hydrogen; passing the hydrogen through a hydrogen-permeable membrane so that the hydrogen enters a second region of the reactor tube which is different from the first region of the reactor tube; and using a sweep gas to remove the hydrogen from the second region of the reactor tube.

In certain embodiments, using solar power to heat the reactor tube includes using a parabolic trough solar collector to transfer solar thermal energy to the reactor tube to heat the reactor tube.

In certain embodiments, using solar power to heat the reactor tube includes: using a photovoltaic panel to generate electrical energy; transferring the electrical energy to a heating element disposed in the reactor tube; and using the heating element to heat the reactor tube.

In certain embodiments, the reactant-containing gas includes ammonia, water, methane, methanol, and/or ethanol.

In certain embodiments, the sweep gas includes steam and/or nitrogen.

In a third aspect, the disclosure provides a system including a reactor tube. The reactor tube includes a first cylinder having an inner surface defining an interior of the first cylinder, a second cylinder including a hydrogen-permeable membrane disposed within the interior of the first cylinder, a catalyst, and a heating element. The reactor tube has an annular space between an interior surface of the first cylinder and an exterior surface of the second cylinder. The reactor tube has an inner space defined by an interior surface of the second cylinder.

In some embodiments, the catalyst and the heating element are disposed in the annular space.

In some embodiments, the catalyst and the heating element are disposed in the inner space.

In some embodiments, the system further includes an enclosure. The heating element is disposed in the enclosure, and the enclosure prevents direct physical contact of the heating element and the catalyst.

### BRIEF DESCRIPTION OF THE FIGURES

FIG. 1A depicts a schematic of a side view of a reactor tube.

FIG. 1B depicts a schematic of a cross-section of a reactor tube taken along the line 1B-1B.

FIG. 2A depicts a schematic of a side view of a reactor tube.

FIG. 2B depicts a schematic of a cross-section of a reactor tube taken along the line 2B-2B.

FIG. 3 depicts a schematic of a system.

FIG. 4 depicts a schematic of a system.

### DETAILED DESCRIPTION

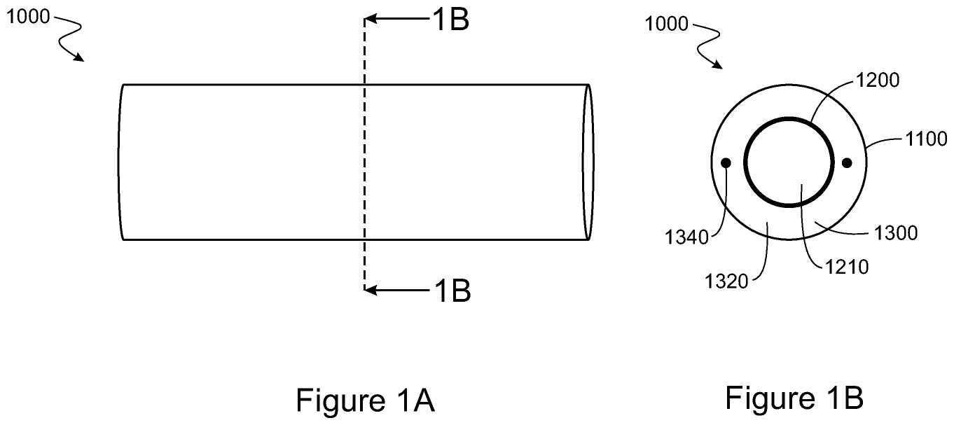

FIG. 1A depicts a side view of a reactor tube 1000 and FIG. 1B depicts a cross section of the reactor tube 1000 taken along the line 1B-1B. The reactor tube 1000 includes an outer tube 1100, an inner tube 1200, annular space 1300 between the tubes 1100 and 1200, and an inner space 1210 within the inner tube 1200. The outer tube 1100 includes an absorber coating. The inner tube 1200 includes a hydrogen-permeable membrane coated on a support. The support includes a porous material (e.g., alumina, zirconia, an alloy, such as stainless steel). A catalyst 1320 and heating elements 1340 are disposed in the annular space 1300. The heating elements 1340 heat the annular space 1300 of the reactor tube 1000 using electrical energy.

During use of the reactor tube 1000, a first gas stream containing a reactant (e.g., ammonia) flows through the annular space 1300 where (as discussed in more detail below) hydrogen (H₂) is generated from the reactant (the ammonia is converted to hydrogen and nitrogen). The hydrogen permeates through the hydrogen-permeable membrane of the inner tube 1200 into an inner space 1210 of the inner tube 1200. Also, during use of the reactor tube 1000, a second gas stream (e.g., steam, nitrogen, argon, one or more other inert gases) passes through the inner space 1210 to remove the hydrogen from the inner space 1210. Thus, one can consider the reactor tube 1000 to be a membrane reactor with the annular space 1300 corresponding to the retentate side and the inner space 1210 of the inner tube 1200 corresponding to the permeate side. The second gas stream removes hydrogen from the inner space 1210 (the permeate side) to avoid an undesirable increase in the partial pressure of hydrogen in the inner space 1210. This can help avoid a decrease in permeation of hydrogen. Therefore, one can consider the second gas stream to be a sweep gas.

The heating element 1340 can include any appropriate material, such as a suitable alloy. Examples of suitable alloys include an alloy of nickel and chromium, and an alloy of iron, nickel and chromium. The enclosure can include a high temperature-resistant ceramic. In some embodiments, the heating element 1340 forms coils.

Solar thermal energy is absorbed by the absorber coating on the outer tube 1100 to heat the reactor tube 1000. Generally, the absorber coating can be selected from any appropriate material and is suitable for use at the desired operating temperature. For example, in some embodiments, the absorber coating is suitable for an operating temperature of room temperature or greater (e.g., at least 300° C., at least 450° C. and/or at most 600° C.) Examples of the absorber coating include a double cermet solar selective coating with dielectrics, a high-temperature transition metal nitride multilayer coating including a metal (e.g., a group VIB, VB and/or IVB transition metal), aluminum and nitrides, and oxides of a high-temperature transition metal nitride multilayer coating. Examples of the dielectrics for the double cermet solar selective coatings with dielectrics include Al₂O₃ and SiO₂.

In general, the catalyst 1320 is selected based on the desired reaction. In some embodiments, for ammonia cracking to generate hydrogen and nitrogen, the catalyst 1320 is suitable for an appropriate temperature range (e.g., at least 500° C. and/or at most 650° C.) Examples of such catalysts include cobalt based catalysts (e.g., a barium-cobalt-cerium catalyst) and ruthenium-based catalysts.

Examples of suitable materials for the hydrogen-permeable membrane of the inner tube 1200 include palladium, a palladium-based alloy (e.g., a palladium-silver alloy, a palladium-copper alloy, a palladium-nickel alloy, a palladium-gold alloy), and a vanadium-based alloy.

In some embodiments, the outer tube 1100 has a length of at least 10 (e.g., at least 20, at least 30, at least 40, at least 50, at least 60, at least 70, at least 80, at least 90) meters (m) and/or at most 100 (e.g., at most 90, at most 80, at most 70, at most 60, at most 50, at most 40, at most 30, at most 20) m. In some embodiments, the outer tube 1100 has a diameter of at least 0.05 (e.g., at least 0.1, at least 0.15, at least 0.2, at least 0.25, at least 0.3, at least 0.35, at least 0.4, at least 0.45, at least 0.5, at least 0.55, at least 0.6, at least 0.65, at least 0.7, at least 0.75, at least 0.8, at least 0.85, at least 0.9, at least 0.95) m and/or at most 1 (e.g., at most 0.95, at most 0.9, at most 0.85, at most 0.8, at most 0.75, at most 0.7, at most 0.65, at most 0.6, at most 0.55, at most 0.5, at most 0.45, at most 0.4, at most 0.35, at most 0.3, at most 0.25, at most 0.2, at most 0.15, at most 0.1) m. In some embodiments, the inner tube 1200 has a diameter of at least 0.025 (e.g., at least 0.05, at least 0.1, at least 0.15, at least 0.2, at least 0.25, at least 0.3, at least 0.35, at least 0.4, at least 0.45, at least 0.5, at least 0.55, at least 0.6, at least 0.65, at least 0.7, at least 0.75, at least 0.8, at least 0.85, at least 0.9) m and/or at most 0.95 (e.g., at most 0.9, at most 0.85, at most 0.8, at most 0.75, at most 0.7, at most 0.65, at most 0.6, at most 0.55, at most 0.5, at most 0.45, at most 0.4, at most 0.35, at most 0.3, at most 0.25, at most 0.2, at most 0.15, at most 0.1, at most 0.05) m.

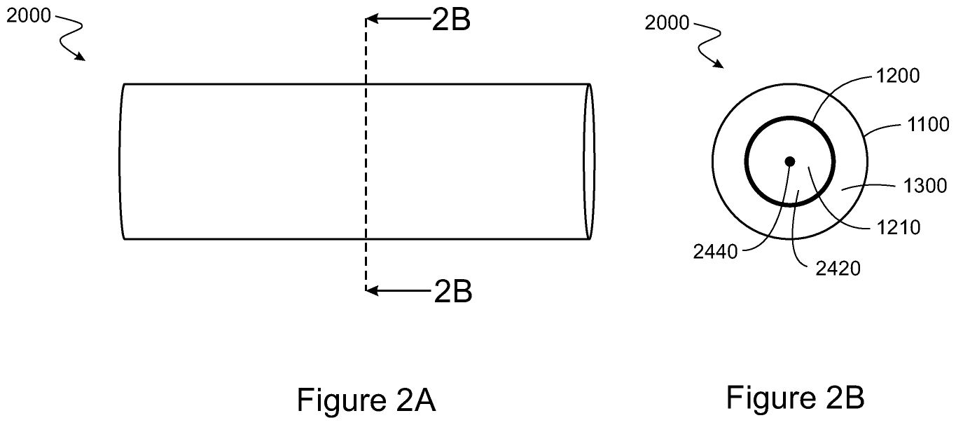

FIG. 2A depicts a side view of a reactor tube 2000 and FIG. 2B depicts a cross section of the reactor tube 2000 taken along the line 2B-2B. The reactor tube 2000 includes the components of the reactor tube 1000. However, unlike the reactor tube 1000, a catalyst 2420 and a heating element 2440 are disposed in the inner space 1210 of the inner tube 1200 rather than in the annular space 1300. With this arrangement, the reactor tube 2000 is used in a manner similar to that described above for the reactor tube 1000, except that the heating element 2440 heats the inner space 1210, the reactant (e.g., ammonia) flows in the inner space 1210 (retentate side), and the second (sweep) gas flows in the annular space 1300 (permeate side).

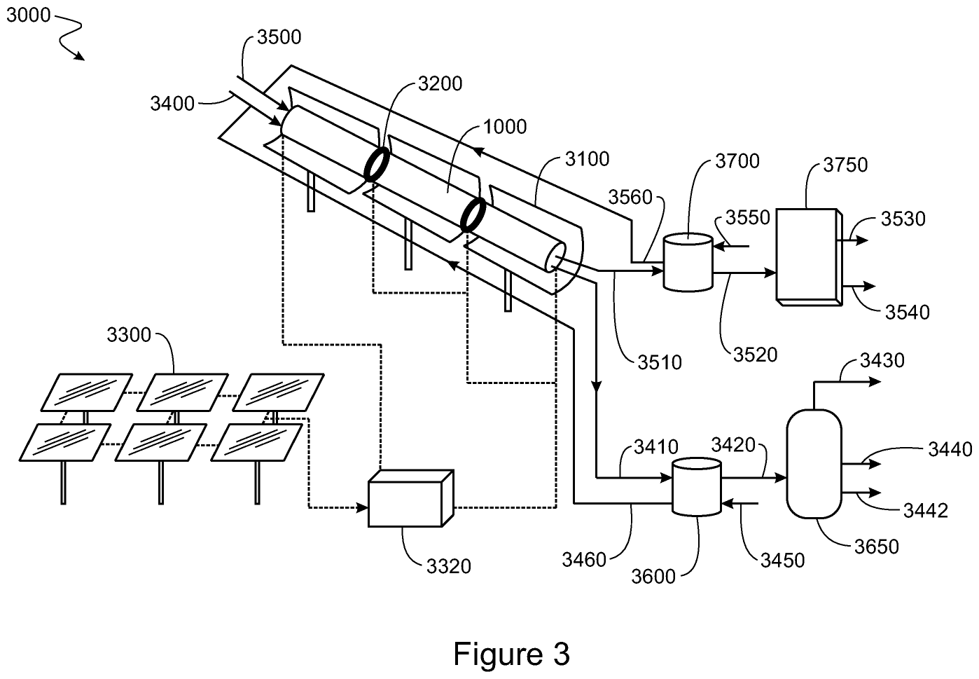

FIG. 3 depicts a system 3000. The system 3000 includes the reactor tubes 1000 and parabolic trough solar collectors 3100. The reactor tubes 1000 are placed at a concentrating line of the parabolic trough solar collectors 3100 so that solar energy collected by the parabolic trough solar collectors 3100 is directed to the reactor tubes 1000 to heat the reactor tubes 1000.

The system 3000 includes additional components to help evenly distribute the heating of the reactor tubes 1000. In particular, the system 3000 includes photovoltaic panels 3300, an electrical energy storage system 3320 and rotors 3200. The photovoltaic panels 3300 collect solar energy and convert it to electrical energy, which is stored in the electrical energy storage system 3320. The electrical energy storage system 3320 provides electrical energy to the rotors 3200 to rotate the reactor tubes 1000 to distribute the concentrated solar thermal energy from the parabolic trough solar collectors 3100 more evenly throughout the surfaces of the reactor tubes 1000.

Further, the system 3000 is configured so that the reactor tubes 1000 can be relatively evenly heated even during times when insufficient solar energy is available. Specifically, during such times, electrical energy stored in the electrical energy storage system 3320 is used to provide electrical energy to the heating elements 1340 of the reactor tubes 1000 to heat the reactor tubes 1000. Additionally, heating can be provided by the thermal energy storage systems 3600 and 3700 to heat the gas streams before being introduced into the reactor tubes 1000 (described in more detail below).

During use of the system 3000, a gas stream 3400 containing reactants (e.g., ammonia) enters the annular space 1300 of the reactor tube 1000 (the retentate side), and a gas stream 3500 enters the inner space 1210 of the inner tube 1200 of the reactor tube 1000 (the permeate side). As the reaction proceeds, hydrogen is produced in the annular space 1300 and permeates through the hydrogen-permeable membrane of the inner tube 1200 into the inner space 1210 of the inner tube 1200. The gas stream 3500 acts as a sweep gas to remove hydrogen from the inner space 1210 of the inner tube 1200.

A gas stream 3510 exits the inner space 1210 of the inner tube 1200 of the reactor tube 1000. The gas stream 3510 contains the sweep gas from the gas stream 3500 as well as the hydrogen that has permeated into the inner space 1210 of the inner tube 1200. The gas stream 3510 is passed through the thermal energy storage system 3700 to store excess thermal energy in an energy storage medium for later usage. The gas stream 3510 can provide heat to the thermal energy storage system 3700, such as during periods of excess solar energy availability. A gas stream 3520 containing the sweep gas (e.g., steam, nitrogen) and hydrogen exits the thermal energy storage system 3700 and enters the post processing unit 3750 where the sweep gas is separated from the generated hydrogen to yield a hydrogen-containing gas stream 3530 and a sweep gas-containing gas stream 3540. In some embodiments, the gas stream 3530 consists of hydrogen. A gas stream 3550, containing the sweep gas, passes through the thermal energy storage system 3700 and exits as a gas stream 3560 to recover stored thermal energy (e.g., the heat provided by the gas stream 3510) to heat the gas stream 3550 before entering the reactor tube 1000. The gas stream 3560 becomes the sweep gas stream 3500.

A gas stream 3410 exits the annular space 1300 of the reactor tube 1000. The gas stream 3410 contains reaction products (e.g., nitrogen and hydrogen) and unreacted reagent (e.g., ammonia). The gas stream 3410 is passed through the thermal energy storage system 3600 to store excess thermal energy in an energy storage medium for later usage. The gas stream 3410 can provide heat to the thermal energy storage system 3600, such as during periods of excess solar energy availability. A gas stream 3420, containing reaction products (e.g., nitrogen hydrogen) and unreacted reagent (e.g., ammonia), exits the thermal energy storage system 3600 and enters the post processing unit 3650 where the generated hydrogen is separated from the non-hydrogen reaction products (e.g., nitrogen) and the unreacted reagent (e.g., ammonia) to yield a hydrogen-containing gas stream 3430, a non-hydrogen product-containing (e.g., nitrogen) gas stream 3440, and a unreacted product-containing (e.g., ammonia) gas stream 3442. In some embodiments, the gas stream 3430 consists of hydrogen. A gas stream 3450, containing the reactant, passes through the thermal energy storage system 3600 and exits as a gas stream 3460 to recover stored thermal energy (e.g., provided by the gas stream 3510) to heat the gas stream 3450 before entering the reactor tube 1000. The gas stream 3460 becomes the gas stream 3400.

Examples of the energy storage medium in the thermal energy storage systems 3600 and 3700 include phase change materials such as fatty acid (e.g., capric acid and lauric acid, paraffins), inorganic materials such as acetamide, hydrated magnesium nitrate, and erythrol, and/or a packed bed of an energy storage material such as alumina.

In some embodiments, the system 3000 uses concentrated solar thermal energy as well as electrical energy generated by the photovoltaic panels 3300 to attain the desired operating temperatures. The desired operating temperature within the reactor tube 1000 depends on the process and feedstock provided by the gas stream 3400. In some embodiments, the desired operating temperature is at least 450 (e.g., at least 460, at least 470, at least 480, at least 490, at least 500, at least 510, at least 520, at least 530, at least 540, at least 550, at least 560, at least 570, at least 580, at least 590) ° C. and/or at most 600 (e.g., at most 590, at most 580, at most 570, at most 560, at most 550, at most 540, at most 530, at most 520, at most 510, at most 500, at most 490, at most 480, at most 470, at most 460) ° C.

Generally, the processes in the post processing unit 3750 depend on the sweep gas. As an example, in certain embodiments, the sweep gas contains steam and the post processing unit 3750 separates the steam from hydrogen by condensation. As another example, in certain embodiments, the sweep gas contains nitrogen and the post processing unit 3750 separates the nitrogen and hydrogen by swing adsorption. Similarly, the processes in the post processing unit 3650 depended on the reactants. As an example, in ammonia cracking to form hydrogen and nitrogen, the post processing unit 3650 includes a water-based ammonia absorption system that separates unreacted ammonia and a system to separate the non-permeated hydrogen from nitrogen gas.

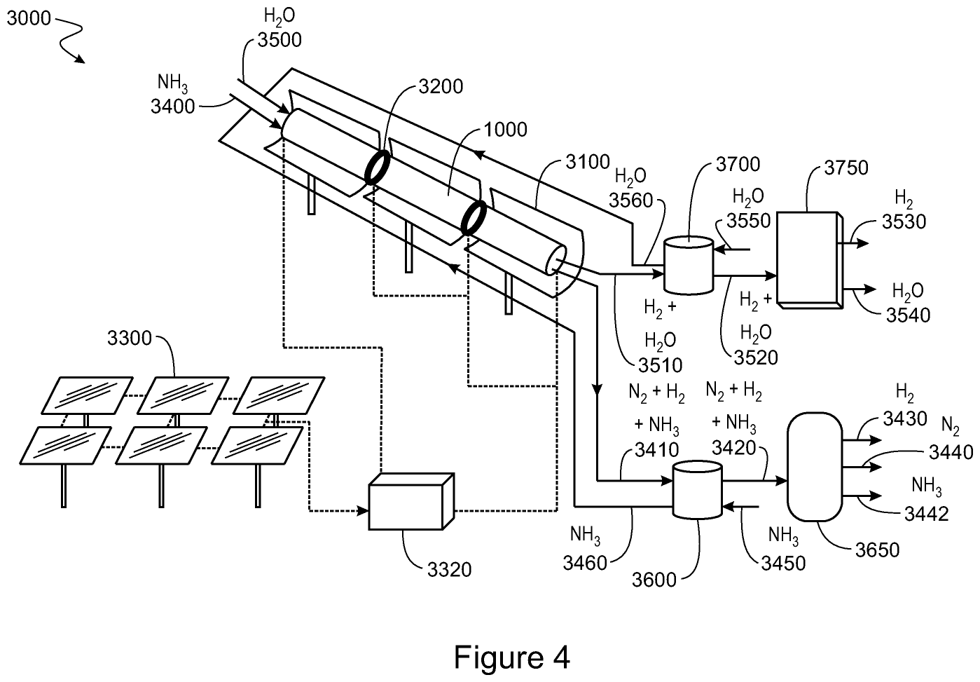

FIG. 4 depicts the system 3000 with the gases in the various gas streams identified, and steam is used as the sweep gas.

In some embodiments, in addition to or instead of the reactor tubes 1000, the system 3000 includes the reactor tubes 2000.

### Other Embodiments

While certain embodiments have been disclosed above, the disclosure is not limited to such embodiments.

As an example, while embodiments have been disclosed that include the components of the reactor tubes 1000 and 2000 and the system 3000; the disclosure is not limited to such embodiments. For example, the reactor tubes 1000 and 2000 and/or the system 3000 can contain one or more additional components not depicted. Additionally, or alternatively, the reactor tubes 1000 and 2000 and/or the system 3000 may not contain each component depicted. Further, components of the reactor tubes 1000 and 2000 and the system 3000 may be reconfigured as appropriate.

As another example, while embodiments of reactor tubes have been described, the disclosure is not limited to such embodiments. For example, in certain embodiments, the reactor tube 1000 and/or 2000 can include an element to avoid direct contact between the catalyst and the heating element(s). In some embodiments, the element can be an enclosure, such as a non-reactive, high temperature-resistant enclosure. Examples of suitable materials for such an enclosure include a high temperature resistant ceramic such as alumina, zirconia, or quartz glass.

As a further example, while embodiments have been disclosed that include the generation of hydrogen and nitrogen through the conversion of ammonia, the disclosure is not limited to such embodiments. More generally, the reactor tubes, systems and methods disclosed herein can be used in any desired reaction that produces hydrogen. As an example, hydrogen can be produced from methane (e.g., steam-methane reforming). As another example, methanol and/or ethanol (e.g., reforming reactions) can be used to generate hydrogen. In some embodiments, the reactants in the gas stream 3400 include ammonia, methane, water, and/or an alcohol (e.g., methanol, ethanol). Further, by selection of appropriate catalyst material and permeable membrane material, the reactor tubes, systems and methods can be used in different chemical reactions to produce and substantially isolate a desired product.

As further example, while embodiments have been disclosed that include the generation of hydrogen using the system 3000, the disclosure is not limited to such embodiments. In certain embodiments, the system 3000 can be used in a dehydrogenation reaction, such as the dehydrogenation of alkanes to alkenes (e.g., propane to propylene, butane to butylene) or the catalytic cracking of light hydrocarbon streams (e.g., naphtha).

What is claimed:

1. A system, comprising:
a reactor tube, comprising:
a first cylinder having an inner surface defining an interior of the first cylinder;
a second cylinder comprising a hydrogen-permeable membrane disposed within the interior of the first cylinder;
a catalyst;
a heating element;
a first inlet; and
a second inlet,
wherein:
the reactor tube has an annular space between an interior surface of the first cylinder and an exterior surface of the second cylinder;
the reactor tube has an inner space defined by an interior surface of the second cylinder;
the first inlet is configured to allow a first gas stream to pass through a first member selected from the group consisting of the annular space and the inner space;
the second inlet is configured to allow a second gas stream to pass through a second member selected from the group consisting of the annular space and the inner space; and
the second member is different from the first member.

2. The system of claim 1, wherein:
the catalyst and the heating element are disposed in the annular space;
the first inlet is configured to allow the first gas stream to pass through the annular space;
the second inlet is configured to allow the second gas stream to pass through the inner space;
the first gas stream comprises a reactant gas; and
the second gas stream comprises a sweep gas.

3. The system of claim 1, wherein:
the catalyst and the heating element are disposed in the inner space;
the first inlet is configured to allow the first gas stream to pass through the inner space;
the second inlet is configured to allow the second gas stream to pass through the annular space;
the first gas stream comprises a sweep gas; and
the second gas stream comprises a reactant gas.

4. The system of claim 1, further comprising a parabolic trough solar collector configured to transfer solar thermal energy to the reactor tube to heat the reactor tube.

5. The system of claim 1, further comprising a photovoltaic panel configured to generate electrical energy transferrable to the heating element.

6. The system of claim 5, further comprising a rotor configured to rotate the reactor tube, wherein the photovoltaic panel is configured to generate electrical energy transferable to the rotor.

7. The system of claim 5, further comprising an energy storage system configured to store the electrical energy generated by the photovoltaic panel.

8. The system of claim 1, further comprising a rotor configured to rotate the reactor tube.

9. The system of claim 1, further comprising:
a first thermal energy storage system configured to heat the first gas stream before the first gas stream enters the reactor tube; and
a second thermal energy storage system configured to heat the second gas stream before the second gas stream enters the reactor tube.

10. The system of claim 1, further comprising an absorber coating supported by an exterior surface of the first cylinder, wherein the absorber is configured to absorb solar energy to heat the reactor tube.

11. The system of claim 1, further comprising an enclosure, wherein:
the heating element is disposed in the enclosure; and
the enclosure prevents direct physical contact of the heating element and the catalyst.

12. A method, comprising:
using solar power to heat a reactor tube;
passing a reactant-containing gas through a first region of the heated reactor tube so that a catalyst in the first region of the heated reactor tube catalyzes a reaction of the reactant-containing gas to produce hydrogen;
passing the hydrogen through a hydrogen-permeable membrane so that the hydrogen enters a second region of the reactor tube which is different from the first region of the reactor tube; and
using a sweep gas to remove the hydrogen from the second region of the reactor tube.

13. The method of claim 12, wherein using solar power to heat the reactor tube comprises using a parabolic trough solar collector to transfer solar thermal energy to the reactor tube to heat the reactor tube.

14. The method of claim 12, wherein using solar power to heat the reactor tube comprises:
using a photovoltaic panel to generate electrical energy;
transferring the electrical energy to a heating element disposed in the reactor tube; and
using the heating element to heat the reactor tube.

15. The method of claim 14, wherein the reactant-containing gas comprises at least one member selected from the group consisting of ammonia, water, methane, methanol, and ethanol.

16. The method of claim 15, wherein the sweep gas comprises a member selected from the group consisting of steam and nitrogen.

17. A system, comprising:
a reactor tube, comprising:
a first cylinder having an inner surface defining an interior of the first cylinder;
a second cylinder comprising a hydrogen-permeable membrane disposed within the interior of the first cylinder;
a catalyst; and
a heating element
wherein:
the reactor tube has an annular space between an interior surface of the first cylinder and an exterior surface of the second cylinder; and
the reactor tube has an inner space defined by an interior surface of the second cylinder.

18. The system of claim 17, wherein the catalyst and the heating element are disposed in the annular space.

19. The system of claim 17, wherein the catalyst and the heating element are disposed in the inner space.

20. The system of claim 17, further comprising an enclosure; wherein,
the heating element is disposed in the enclosure; and
the enclosure prevents direct physical contact of the heating element and the catalyst.
